(19) United States
(12) Patent Application Publication
(10) Pub. No.: US 2025/0136513 A1
(43) Pub. Date: May 1, 2025

(54) MULTI-COMPONENT COMPOSITION FOR PRINTABLE MORTAR

(71) Applicant: KNAUF GIPS KG, Iphofen (DE)

(72) Inventors: Rauno BAESE, Iphofen (DE); Christian ENGERT, Iphofen (DE); Thorsten GESCHWANDTNER, Iphofen (DE); Bernhard FEICHTENSCHLAGER, Trostberg (DE); Michael SCHINABECK, Trostberg (DE); Tanja Petra WEISS, Trostberg (DE); Matthias Josef HOFMANN, Trostberg (DE)

(21) Appl. No.: 18/836,898

(22) PCT Filed: Feb. 22, 2022
(86) PCT No.: PCT/EP2022/000017

§ 371 Date: Aug. 8, 2024

(51) Int. Cl. C04B 28/04; B28B 1/00; B33Y 10/00; B33Y 70/10; C04B 7/02; C04B 7/32; C04B 22/00; C04B 24/04; C04B 24/06; C04B 24/12; C04B 103/10; C04B 103/44; C04B 111/00

(52) U.S. Cl. CPC C04B 28/04; B28B 1/001; B33Y 10/00; B33Y 70/10; C04B 7/02; C04B 7/323; C04B 22/0093; C04B 24/045; C04B 24/06; C04B 24/122; C04B 2103/10; C04B 2103/44; C04B 2111/00181; C04B 2111/00646; C04B 2201/50

(57) ABSTRACT

Multi-component compositions for the preparation of extrudable mortars, which include a mortar base component including Portland cement, an additive for hydration control, a polyhydroxy compound and water and an accelerator component, which includes an alkali metal aluminate. The multi-component compositions enable a simple processing in conventional 3D mortal extrusion printing devices, where the viscosity can be adjusted independent from the accelerator. Also included are cementitious compositions prepared from such multi-component compositions, a 3D printing process using such mixed compositions as a printing material, as well as 3D structures which have been prepared via a corresponding printing process.

The present application is concerned with multi-component compositions for the preparation of extrudable mortars, which comprise a mortar base component on the basis of comprising Portland cement, an additive for hydration control, a polyhydroxycompound and water and an accelerator component, which comprises an alkali metal aluminate. The present application further comprises cementitious compositions prepared form such multi-component compositions, a 3D printing process using such mixed compositions as a printing material, as well as 3D structures which have been prepared by means a corresponding printing process.

### STATE OF THE ART

Additive manufacturing of cement-bonded structures today is essentially divided into three different basic processes, which are the powder bed method, printing via shotcrete and extrusion.

In the powder bed method either a granulation or a granulation-cement-dry mixture is provided as a powder bed. Onto this bed, a cement suspension or water, depending on the structures to be printed, is then applied via the print head of a printer. Subsequently, a further layer of dry material is applied on top of the previous powder bed and the process is repeated until the desired structure has been printed. Given that in such process the size of a platform, on which the object is prepared is a limiting factor, this method is mostly used for the preparation of smaller objects.

The shotcrete method in 3D printing is analogous to known shotcrete applications, where a flowable cement is shot from an ejection nozzle to its intended position. The difference in this method vis-à-vis a regular shotcrete application is that the shotcrete is automatically applied, which enables the production of previously programmed 3D structures. Shotcrete is regularly applied pneumatically.

The third possible 3D-application process for concrete is by extrusion from a print head, wherein continuous strands of concrete are applied layer on layer or in bundles of layers, which then form the structures to be produced. In extrusion, an accelerator can be added to the printhead to enable rapid stiffening and setting. This technique has been tested in various prototypes, including the printing of buildings.

A obvious requirement for both cement compositions in the shotcrete method and for extrusion applications is that the compositions after mixing with water have to be sufficiently flowable until they have been deposited on the intended location, but should be cure sufficiently fast to be able to apply a subsequent layer of material on a previous layer with minimal deformation of the previous layer. Further requirements for mortars, which are suitable for use in a 3D extrusion process are long open time, good pumpability, good extrudability, easy acceleration and fast layer build-up.

To meet these requirements, recipes of suitable concrete compositions are known and have been published in the prior art mostly for application via an extrusion process. In the corresponding compositions, the binders are predominantly mixtures of OPC (ordinary Portland Cement), calcium aluminate cement (CAC) and a sulphate source. In some cases, there are also formulations in which the binding agent consists mainly of a calcium aluminate cement (WO 2018/083010 A1). These recipes usually comprise mayor quantities CAC as a binding agent in order to achieve the fastest possible hardening and thus a high early strength. However, such recipes suffer from high costs and sometimes also provide lower final strengths. In addition, if hardening is accelerated the time where the mortar can be processed in a printing machine can be very short, which can complicate the preparation process.

In addition, mortars for which accelerated hardening is not intended, have been described. While such mortars can be readily processed in a printing apparatus, they have the disadvantage that they do not harden quickly enough, which results in a slow construction progress.

As noted above, mortars for a 3D application have to be processable in an application apparatus, which requires that water in the composition is available for a sufficient amount of time before it is taken up in the cement structure. This is a particular problem for mortars based on Portland cement, where hydration typically occurs rapidly, so that suspension of Portland cement in water cannot be extruded in formable, viscous state as required for 3D printing.

To overcome this problem, WO 2019/077050 A1 describes a setting retarder on the basis of an amine glyoxlic acid condensate, which is used in combination with a carbonate or borate source. For these compositions, it was observed that an early strength of up to 2.5 MPa and in one case even 4 MPA could be achieved after 4 h, whereas compositions only comprising the glyoxlic acid condensate or the carbonate or borate source did not reach a strength of 1 MPa after this time.

WO 2020/244981 A1 describes an additive kit for the preparation of a 3D printing mortar, which comprises a combination of hardening retarders and hardening accelerators, wherein the hardening retarders are selected from glyoxylic acid, salts thereof, condensation or addition products of glyoxylic acid or salts thereof, and mixtures thereof and the hardening accelerators are i.a. calcium-silicate-hydrate or calcium hydroxide. The compositions of WO 2020/244981 A1 have been shown to provide sufficient flowability properties to be processed via 3D printing equipment and sufficient curing within 10 to 15 minutes to apply a further layer without critical deformation of previous layers. One downside of this mortar is however, that it has low final strength.

WO 2020/212607 A1 describes a similar additive technology for use in in the preparation of shotcrete, where aluminium sulfate solutions are used as accelerators. In this case, however, it is somewhat problematic that aluminium sulfate at the same time as accelerating the curing affects the rheology and increases the viscosity of the composition, which can thus not be controlled and adjusted independent from the hardening.

In consideration of this prior art, there is a need for a sufficiently inexpensive printing mortar composition, which can be processed via conventional 3D mortar printing equipment and where the curing accelerator has little or no influence on the final strength of the cured product. In addition, it would be preferable that the accelerator does also not have a direct impact on the viscosity of the composition, so that the composition is easier to process and the viscosity can be adjusted as required.

The present application addresses these needs.

### DESCRIPTION OF THE INVENTION

As noted above, it was an objective of the present invention to propose a mortar composition for use in 3D mortar printing applications, wherein the mortar is based at least to the primary extent on Portland cement, and where the curing behaviour is such that the mortar can readily be processed in the 3D printing apparatus while after an initial delay the mortar rapidly sets to provide a high early and final strength and the viscosity of the composition can be adjusted independently from a curing accelerator, which is added.

Accordingly, in a first aspect, the application concerns a multi-component composition comprising a mortar base component A comprising a mixture of
a1) Portland cement as a hydraulic binder,
a2) an amine-glyoxylic acid condensate selected from the group consisting of a melamine-glyoxylic acid condensate, an urea-glyoxylic acid condensate, a melamine-urea-glyoxylic acid condensate and a polyacrylamide-glyoxylic acid condensate and mixtures thereof,
a3) at least one polyhydroxy compound or a salt or ester thereof, and
a4) water;
   and an accelerator component B comprising an alkali metal aluminate.

A “multi-component composition”, as this term is used in the context of this application, means a composition, which is intended for subsequent mixing of its individual components, but where the components are kept separate from each other (e.g. in individual separate compartments) prior to the intended use. Hence the “multi-component composition” is similar to a kit, which is a combination of components or items, which are intended to be used together, but which at the kit stage have not yet been combined.

A hydraulic binder is a substance which, after being mixed with water (and even in absence of other substances), solidifies and hardens independently as a result of chemical reactions with the water, and which, after hardening, remains solid and stable in space even under water.

By mixing components A and B, and, if applicable, further components, a cementitious composition, especially a mortar, is obtained. For suitable mortars, often at least one granulate is present. Non-reactive granulates may also be designated as fillers in the context of this invention. Fillers do not work as hydraulic binders, i.e. have no capability to do hydraulic reactions to build-up strength when mixed with water alone. Fillers are—generally granular—components which may be present in higher concentrations, e.g. to change the mechanical or processing properties of the mortar, and/or to reduce the proportion of more expensive base material (the matrix; especially binder and other co-components) in the finished product.

It is very preferred that the filler is a constituent of component A before mixing components A and B, so that in such cases component A comprises or consists of a mixture of
a1) Portland cement as a hydraulic binder,
a2) an amine-glyoxylic acid condensate selected from the group consisting of a melamine-glyoxylic acid condensate, an urea-glyoxylic acid condensate, a melamine-urea-glyoxylic acid condensate and a polyacrylamide-glyoxylic acid condensate and mixtures thereof,
a3) at least one polyhydroxy compound or a salt or ester thereof,
a4) water, and
a5) one or more granular filler(s).

In the following, the terms “apparatus” and “device” in relation to printing equipment for the application and processing of inventive multi-component compositions are used interchangeably and have the same meaning.

In the investigations underlying the present invention, it has unexpectedly been discovered that the combined use of amine-glyoxylic acid condensates as a hydration retarder for the Portland cement and an accelerator component comprising an alkali metal aluminate provides a highly beneficial curing profile and in particular good early and final strength of the cementitious composition, which is prepared form the multi-component composition. In the compositions, the amine-glyoxylic acid condensates provide for sufficient hardening delay to enable the production of the Portland cement water mixture, which can then be transported to a mixing chamber just before the discharge nozzle of the composition form the printing device. In the mixing chamber, the hardening accelerator is then admixed to the mortar water mixture, so that after the placement thereof to its desired location the mortar quickly cures. In comparison the aluminium sulfate, which is used e.g. in WO 2020/212607 A1 as a curing accelerator, the alkali metal aluminate has no immediate impact on the viscosity of the mixture, so that the viscosity can be adjusted independently from the accelerator addition, e.g. via the addition of an appropriate thickener.

The term “Portland cement” denotes any cement compound containing Portland clinker, especially CEM I, II, III, IV and V within the meaning of standard EN 197-1, paragraph 5.2. A preferred cement is ordinary Portland cement (OPC) according to DIN EN 197-1 which may either contain calcium sulfate (<7% by weight) or is essentially free of calcium sulfate (<1% by weight). In this text, the general term “calcium sulfate” comprises any modification thereof, as e.g. hemihydrate (α-hemihydrate, β-hemihydrate), dihydrate (gypsum), anhydrite. Further, some cements may contain soluble alkali sulfates, typical ranges are 0-2% by weight. In the component A, Portland cement may be the only hydraulic binder or Portland cement may be used in combination with other hydraulic binders. Possible hydraulic binders, which may be used with Portland cement in the mortar base component A include e.g. calcium aluminate cement, sulfoaluminate cement and mixtures thereof.

Calcium aluminate cement (also referred to as high aluminate cement) means a cement containing calcium aluminate phases. The term “aluminate phase” denotes any mineralogical phase resulting from the combination of aluminate (of chemical formula Al₂O₃, or “A” in cement notation), with other mineral species. The amount of alumina (in form of Al₂O₃) is ≥30% by weight of the total mass of the aluminate-containing cement as determined by means of X-ray fluorescence (XRF). More precisely, said mineralogical phase of aluminate type comprises tricalcium aluminate (C₃A), monocalcium aluminate (CA), mayenite (C₁₂A₇), tetracalcium aluminoferrite (C₄AF), or a combination of several of these phases.

Sulfoaluminate content of yeelimite (of chemical formula 4CaO·3Al₂O₃·SO₃ or C₄A₃$ in cement notation) of greater than 15% by weight. Here, and throughout this application C stands for CaO, S stands for SiO₂, A stands for Al₂O₃, $ stands for SO₃ and H stands for H₂O according to conventional cement notification.

Regularly, if aluminate cements are present, the mortar base component A comprises aluminate cements in an amount of less than the amount of the Portland cement. In a preferred embodiment, the mortar base component A comprises aluminate cements in an amount of less than 10% by weight, preferably less than 5% by weight, based on the combined weight of the constituents of component A without water. In a particularly preferred embodiment, the component A is free of aluminate cements. In addition, it is preferred that the mortar base component A comprises sulfoaluminate cements in an amount of less than 10% by weight, preferably less than 5% by weight, based on the combined weight of the constituents of component A without water.

As a second component a2), the component A comprises an amine-glyoxylic acid condensate which is selected from the group consisting of a melamine-glyoxylic acid condensate, an urea-glyoxylic acid condensate, a melamine-urea-glyoxylic acid condensate and a polyacrylamide-glyoxylic acid condensate, or a mixture of such condensates. Preferably, the amine-glyoxylic acid condensate is an urea-glyoxylic acid condensate. The task of component a2) is to act as a setting retarder (also referred to as hardening retarder).

The amine-glyoxylic acid condensates are obtainable by reacting glyoxylic acid with a compound containing aldehyde-reactive amino or amido groups. The glyoxylic acid can be used as an aqueous solution or as glyoxylic acid salts, preferably glyoxylic acid alkaline metal salts. Likewise, the amine compound can be used as salt, for example as guanidinium salts. In general, the amine compound and the glyoxylic acid are reacted in a molar ratio of 0.5 to 2 equivalents, preferably 1 to 1.3 equivalents, of glyoxylic acid per aldehyde-reactive amino or amido group. The reaction is carried out at a temperature of 0 to 120° C., preferably 25 to 105° C., most preferably 50 to 105° C. The pH value is preferably from 0 to 8. The viscous products obtained in the reaction can be used as such, adjusted to a desired solids content by dilution or concentration or evaporated to dryness by, e.g., spray-drying, drum-drying, or flash-drying.

In general, the amine-glyoxylic acid condensates have molecular weights in the range of from 500 to 25000 g/mol, preferably 1000 to 10000 g/mol, particularly preferred 1000 to 5000 g/mol. The molecular weight is measured by the gel permeation chromatography method (GPC).

The amine-glyoxylic acid condensate a2) is included into the mortar base component A in an amount which is sufficient to delay hydration of the Portland cement to the required amount. Preferably, the amine-glyoxylic acid condensate is included in the mortar base component A in an amount of from 0.05 to 2 wt.-%, in particular of from 0.1 to 1 wt.-% and especially preferred of from 0.2 to 0.5 wt.-%, based on the combined weight of the non-aqueous constituents in the component A.

As a third component a3), the component A comprises a polyhydroxy compound or a salt or ester thereof, which provides an optimized control of hydration of the Portland cement and optional other binders. This allows to obtain higher strength in the composition after it has been fully cured.

As used herein, the term polyhydroxy compound refers to an organic compound comprising at least two, and preferably at least three hydroxy groups. The carbon chain of the compound may be linear or cyclic. Preferably, the polyhydroxy compound only comprises carbon, oxygen, hydrogen, and optionally nitrogen atoms.

In a preferred embodiment, the polyhydroxy compound is selected from polyalcohols with a carbon to oxygen ratio of C/O≥1, preferably from C/O≥1 to C/O≤1.5, more preferably from C/O≥1 to C/O≤1.25, and mixtures thereof.

In another preferred embodiment, the polyhydroxy compound has a molecular weight of from 62 g/mol to 25000 g/mol, preferably from 62 g/mol to 10000 g/mol and most preferably from 62 g/mol to 1000 g/mol.

In a particularly preferred embodiment, the polyhydroxy compound is selected from sugar alcohols and their condensation products, alkanolamines and their condensation products, carbohydrates, pentaerythritol, trimethylolpropane, and mixture thereof.

As used herein, sugar alcohols preferably include sugar alcohols based on C₃-C₁₂-sugar molecules. Preferred sugar alcohols include glycerol, threitol, erythritol, xylitol, sorbitol, inositol, mannitol, maltitol, and lactitol. A particularly preferred sugar alcohol is glycerol.

As used herein, the term alkanolamines refers to polyhydroxy compounds comprising at least one amino group. Exemplary alkanolamines include diethanolamine, methyl diethanolamine, butyl diethanolamine, monoisopropanolamine, diisopropanolamine, methyl diisopropanolamine, triethanolamine, tetrahydroxypropylethylenediamine, trimethylaminoethylethanolamine, N,N-bis(2-hydroxyethyl) isopropanolamine, N,N,N′-trimethylaminoethylethanolamine, and N,N,N′,N′-tetrakis(2-hydroxypropyl)ethylenediamine.

As used herein, the term carbohydrate refers to sugars, starch, and cellulose. Preferably, the term carbohydrate is intended to refer to sugars, i.e. mono- and disaccharides. Preferred carbohydrates according to the invention include glucose, fructose, sucrose, and lactose.

In a more preferred embodiment of the invention, the polyhydroxy compound is selected from glycerol, threitol, erythritol, xylitol, sorbitol, inositol, mannitol, maltitol, lactitol, pentaerythritol, trimethylolpropane, and mixture thereof. In a particularly preferred embodiment, the polyhydroxy compound is glycerol.

As indicated above, the polyhydroxy compound may also be used in the form of the salt or ester thereof. Suitable salts include metal salts such as alkali metal, alkaline earth metal, zinc, and iron salts, ammonium salts, and phosphonium salts. Preferred are metal salts, and in particular alkali metal salts.

Suitable esters include saturated or unsaturated C₁-C₂₀-carboxylic acid esters, preferably C₂-C₁₀-carboxylic acid esters, such as acetic acid esters. The carboxylic acid moiety may be unsubstituted or substituted by one or more substituents selected from halogen, OH, and ═O.

The polyhydroxy compound a3) is preferably included into the mortar base component A in an amount of from 0.01 to 1 wt.-%, in particular of from 0.05 to 0.5 wt.-% and especially preferred for 0.1 to 0.3 wt.-% based on the combined weight of the non-aqueous constituents of the component A.

As a fourth constituent a4), the mortar base component comprises water, which is conventionally added to sufficiently fluidize the composition. Preferably, the water is incorporated into the component A in an amount to provide a water cement ratio in the range of from 0.2 to 1.0 and particularly preferably 0.4 to 0.7. An especially preferred water cement ratio is 0.5±0.02 und in particular 0.5±0.01.

As further constituents, the component A in most instances will further contain fine granulates (e.g. non-reactive fillers and/or reactive aggregates), i.e. granulates whose diameter is between 150 mm and >2 mm (for example sand and/or gravel), and/or optionally very fine granulates and/or coarse granulates, i.e. granulates with a diameter of ≤2 mm (for example silt, rock flour, rock powder, clay). In one embodiment, the multi-component composition only comprises granulates, in particular in the form of sand and especially quartz sand, which have a particle size of ≤2 mm and preferably in the range of 0.05 to 2 mm (the terms sand/quarts sand here shall include silt grains).

Non-reactive fillers generally are unsoluble in the matrix and do not react with other constituents in the multi-component composition (including the water), but will once be integrated into the hardened mortar, especially homogeneously integrated.

The multi-component composition may also comprise reactive aggregates. In the context of this invention, the term “reactive aggregates” shall mean inorganic compounds that have no capability to do hydraulic reactions to build-up strength when mixed with water alone, but which show—in combination with other components such as Portland cement or calcium hydroxide an—at least partial—reaction which contributes to the strength of the overall material.

Granulates can for example be non-reactive filler such as silica, quartz, sand, crushed marble, glass spheres, granite, limestone, sandstone, calcite, marble, serpentine, travertine, dolomite, feldspar, gneiss, alluvial sands, any other durable aggregate, and mixtures thereof. These granulates or fillers do not work as a binder, i.e. they do not react with other constituents in the multi-component composition.

Alternative or in addition to non-reactive fillers, the inventive multi-component composition may comprise reactive aggregates such as puzzolanes, in particular in the form of fly ash, slags, calcined clays, e.g. metacaoline, microsilica, fine calcium carbonate or mixtures thereof.

Preferably, the binder component a1), and if present, the filler component a5), and, if present, reactive aggregates, as well as, if present, further cement components (“Non-Portland cements”) add to 88-99% by weight based on the combined weight of the non-aqueous constituents of the component A. Further preferred, thereof 30-90%, more preferred 40-70% by weight based on the combined weight of the non-aqueous constituents of the component A are fillers and/or reactive aggregates, and the difference to the above mentioned amounts is provided by the binders, i.e. only Portland cement or Portland cement and other hydraulic binders, especially as defined above.

The accelerator in accelerator component B of the inventive multi-component composition is an alkali metal aluminate. A preferred alkali metal aluminate is sodium or potassium aluminate, particularly preferred is sodium aluminate (NaAlO₂).

The accelerator component B is preferably an aqueous solution of the alkali metal. aluminate, wherein the concentration of the alkali metal aluminate is suitably in the range of from 30 to 60 wt.-% and in particular of from 35 to 50 wt.-%.

In addition, in one embodiment in addition to an alkali metal aluminate the accelerator component B may comprise a soluble sulfate source, preferably in the form of aluminium sulfate, although the addition of aluminium sulfate is to be limited to an extent that it does not detrimentally interfere with the alkali metal aluminate accelerating agent. Preferably, if aluminium sulfate is present the weight ratio of alkali metal aluminate to aluminium sulfate is >1:1, more preferably at least 2:1, even more preferably at least 5:1 and even more preferably at least 10:1.

As noted above, the accelerator component B in the inventive multi-component composition in contrast to e.g. aluminium sulfate does not have the effect of at the same time affecting the viscosity of the composition, so that the viscosity can be adjusted independent from the accelerator component. Preferably, thus, the multi-component composition thus further comprises a thickener component C. For the sake of processability, where a lower viscosity of the mortar base component A is favorable, the thickener is usually not included in this component, but is preferably added concurrently with the accelerator component B.

The thickener in the thickener component can be any thickener suitable for the incorporation into cementitious composition. Suitable thickeners include e.g. modified starch, amylopectin, modified cellulose, microbial polysaccharides, galactomannans, alginate, tragacanth, polydextrose, superabsorbent or mineral thickener.

The thickener is preferably selected from the group consisting of modified starches, modified celluloses, microbial polysaccharides, superabsorbents and mineral thickeners.

The modified starch thickener is preferably a starch ether, in particular hydroxypropyl starch, carboxymethyl starch or carboxymethyl hydroxypropyl starch.

The modified cellulose is preferably methyl cellulose, ethyl cellulose, carboxymethyl cellulose, hydroxymethyl cellulose, hydroxyethyl cellulose or methylhydroxyethyl cellulose.

The microbial polysaccharide is preferably welan gum, xanthan gum or diutan gum.

The superabsorbent is preferably selected from the group comprising polyacrylamide, polyacrylonitrile, polyvinyl alcohol, isobutylene-maleic anhydride copolymers, polyvinylpyrrolidone, homo- and copolymers of monoethylenically unsaturated carboxylic acids such as (meth)acrylic acid, crotonic acid, sorbic acid, maleic acid, fumaric acid, itaconic acid, preferably polyacrylic acid, which can be partially or completely neutralized Copolymers and terpolymers of the monoethylenically unsaturated carboxylic acids mentioned with vinylsulfonic acid, (meth)acrylamidoalkylsulfonic acids, allylsulfonic acid, vinyltoluenesulfonic acid, Vinylphosphonic acid, (meth)acrylamide, N-alkylated(meth) acrylamide, N-methylol (meth)acrylamide, N-vinylformamide, N-vinyl acetamide, vinyl pyrrolidone, hydroxyalkyl (meth)acrylate, ethyl acrylate, methyl acrylate, (meth)acrylic acid esters of polyethylene glycol monoallyl ethers, Vinyl acetate and/or styrene. Preferred as a superabsorbent thickener is a polyacrylamide thickener.

The superabsorbent homo- and copolymers can be linear or branched, the copolymers can be present randomly or as block or gradient polymers. The homopolymers and copolymers are preferably also crosslinked.

The mineral thickener is preferably a special silicate or clay mineral, in particular a bentonite or sepiolite, preferably sepiolite.

The thickener in the thickener component C can be a thickener in dry or fluid form, or can be formulated as a mixture of the thickener and water to facilitate mixing and even distribution of the thickener in a mixture of components A, B and C.

The thickener is preferably added in an amount to provide a slump (as determined according to din EN 1015-3/2007) in the range of 14 to 30 cm directly after mixing with the component B of the inventive multi-component composition. In addition, or as alternative thereto, the thickener is added in an amount of from 0.001 to 1.0 wt.-%, based on the total solids weight of the mortar.

As concerns the amounts of the respective components A, B and C in the multi-component composition of the invention, it is preferred that the non-aqueous constituents of the mortar base component A account for 99 to 90 wt.-% of the composition, the accelerator component B accounts for 0.5 to 5 wt.-% of the composition and the optional thickener component C accounts up to 1 wt.-% of the composition, each on dry basis.

As also noted above, the Portland cement in the mortar base component A can be used in combination with calcium sulfate, which has the effect of improving the strength of the hardened composition (via the facilitating the formation of ettringit). Moreover, the shrinkage can be beneficially affected by the addition of calcium sulfate. Preferably, the content of calcium sulfate is equal to or less than 5 wt.-% of the combined weight of the non-aqueous components in the mortar base component A, and particularly preferably, the mortar base component A contains from 0.5 to 3 wt.-% calcium sulfate, relative to the combined weight of the non-aqueous components in the mortar base component A.

Although in most cases part of component A, in other embodiments the fillers and/or reactive aggregates may alternatively or additionally be present in another component of the multi-component composition or represent an individual component D. In these cases, when the components of the multi-component composition are admixed to obtain the mortar, the respective fillers and/or reactive aggregates will not—or not only, respectively—be introduced being part of component A, but as a constituent of one or more of the other components or as an individual component D.

Especially in cases where the filler and/or reactive aggregates is not a constituent of component A, the ratios of components B and C to component A may be higher. Generally, the combined amount of fillers and/or reactive aggregates in the inventive multi-component composition is preferably 30 to 90 wt.-%, based on the solids in the composition and more preferably 40 to 60 wt.-%.

Alternatively, a multi-component composition without fillers or with an reduced amount of fillers and/or cement compound a1) and/or reactive aggregates may be used to be admixed and applied, especially be printed, onto a powder bed made of granulation or a granulation-cement-dry mixture.

In addition, the inventive multi-component composition of the invention may comprise one or more additives, which are conventional for use in mortar and cementitious compositions. Preferably, if such additives are present they are comprised in the mortar base component A, so that during the processing of the composition only the accelerator and optional thickener in the components B and C have to be thoroughly mixed into the composition.

Suitable additives for use inventive multi-component composition include, next to those already mentioned above, one or more of a dispersing agent, a rheology adjusting additive, a surfactant or flowing agent, a carbonate source, a hydroxylic acid, a shrinkage reducer, and an (air) pore former.

Suitable dispersing agents, which can be present in the multi-component composition of the invention, include i.a.
comb polymers having a carbon-containing backbone to which pendant cement-anchoring groups and polyether side chains are attached,
non-ionic comb polymers having a carbon-containing backbone to which pendant hydrolysable groups and polyether side chains are attached, where the hydrolysable groups upon hydrolysis release cement-anchoring groups,
sulfonated melamine-formaldehyde condensates,
lignosulfonates,
sulfonated ketone-formaldehyde condensates,
sulfonated naphthalene-formaldehyde condensates,
phosphonate containing dispersing agents, preferably where the phosphonate containing dispersing agents comprise at least one polyalkylene glycol unit,
cationic (co)polymers, and
   mixtures thereof.

A more exhausting list of dispersing agents, which can be used in the multi-component compositions of this invention, is provided on pages 7 to 19 of WO 2020/244981 A1, the relevant contents of which are hereby incorporated by reference into this application in their entirety.

The carbonate source may be an inorganic carbonate having an aqueous solubility of 0.1 g/L—or more. The aqueous solubility of the inorganic carbonate is determined in water (starting at pH 7) at 25° C. These characteristics are well known to those skilled in the art. The inorganic carbonate may be selected from alkaline metal carbonates such as potassium carbonate, sodium carbonate or lithium carbonate, and alkaline earth metal carbonates satisfying the required aqueous solubility, such as magnesium carbonate. It is also possible to use guanidine carbonate as an inorganic carbonate, as well as sodium hydrogencarbonate and potassium hydrogencarbonate.

Alternatively, the carbonate source is selected from organic carbonates. “Organic carbonate” denotes an ester of carbonic acid. The organic carbonate is hydrolyzed in the alkaline environment generated by the cementitious system to release carbonate ions. In an embodiment, the organic carbonate is selected from ethylene carbonate, propylene carbonate, glycerol carbonate, dimethyl carbonate, di(hydroxyethyl)carbonate or a mixture thereof, preferably ethylene carbonate, propylene carbonate, and glycerol carbonate or a mixture thereof, and in particular ethylene carbonate and/or propylene carbonate. Mixtures of inorganic carbonates and organic carbonates can as well be used.

In a preferred embodiment, the carbonate source is an inorganic carbonate. In a more preferred embodiment, the inorganic carbonate is selected from potassium carbonate, sodium carbonate, lithium carbonate, magnesium carbonate, and mixtures thereof, and is preferably sodium carbonate.

Examples of hydroxylic acids or salts thereof are e.g. citric acid, tartaric acid, gluconic acid, salts, hydrates, and combinations thereof, preferred hydroxylic acid salts are trisodium citrate or and a hydrate thereof, e.g. trisodium citrate di-hydrate.

A rheology additive can contribute to the dimensional stability of the multi-component composition in the mortar base component A and can optimize the processability of this component prior to incorporation of the components B and C. Suitable rheology additive are basically the same as described previously of the thickener in the thickener component C, i.e. modified starch, amylopectin, modified cellulose, microbial polysaccharides, galactomannans, alginate, tragacanth, polydextrose, superabsorbents or mineral thickeners. The content of rheology additives in the component A is usually within 0 to 0.5 wt.-%, based on the weight of the non-aqueous constituents in this composition.

Possible shrinkage reducers include e.g. superabsorbents. The content of shrinkage reducers in the component A is usually within 0 to 1.5 wt.-%, based on the weight of the non-aqueous constituents in this composition.

Possible surfactants and flowing agents include in particular sodium gluconate, lignosulfonate, sulfonated naphthalene-formaldehyde condensate, sulfonated melamine-formaldehyde condensate, sulfonated vinyl copolymer, polyalkylene glycol with phosphonate groups, polyalkylene glycol with phosphate groups or an aromatic condensate with phosphonate groups and polyalkylene glycol chains. The content of surfactants and flowing agents in the component A is usually within 0 to 0.2 wt.-%, based on the weight of the non-aqueous constituents in this composition.

Possible (air) pore forming agents are for example those described in EP 1 433 768 B1, the relevant content of which is herewith incorporated by reference in its entirety. The content of (air) pore forming agents in the component A is usually within 0 to 0.2 wt.-%, based on the weight of the non-aqueous constituents in this composition.

The content of additives—with exception of fillers and reactive aggregates, retarder component a2) and polyhydroxy compound a3)—which are comprised in the component A is in most cases equal to or less than 10 wt.-%, preferably equal to or less than 5 wt.-% and even more preferably in the range of about 0.5 to 3 wt.-%.

In a further aspect, the present application concerns a cementitious composition, which is obtainable by or obtained by mixing the components of a multi-component composition as described above. In a particularly preferred embodiment of this aspect, the composition is formulated such that 2 h after mixing the composition has a compressive strength of at least 1 N/mm², in particular at least 2 N/mm² and even more preferably in the range of 3 to 10 N/mm². In addition, the cementitious composition preferably 28 days after mixing has a compressive strength of at least 40 N/mm² and in particular a compressive strength in the range of from 50 to 70 N/mm². As the accelerator in the accelerator component is the parameter, which has the most influence on obtaining such compressive strength, the skilled practitioner can determine the required amount of this ingredient and thus a composition to provide a corresponding compressive strength in a simple set of experiments. In the context of this invention, the compressive strength is determined according to DIN EN 196-1:2016.

In a yet further aspect, the present application concerns a process for the production of a 3D structure, which comprises the steps of
(i) providing a mixture of a mortar base component A comprising
   a1) Portland cement as a hydraulic binder,
   a2) an amine-glyoxylic acid condensate selected from the group consisting of a melamine-glyoxylic acid condensate, an urea-glyoxylic acid condensate, a melamine-urea-glyoxylic acid condensate and a polyacrylamide-glyoxylic acid condensate and mixtures thereof,
   a3) at least one polyhydroxy compound or salts or esters thereof, and
   a4) water;
(ii) mixing the mortar base component A with an accelerator component B comprising an alkali metal aluminate to obtain the 3D printing composition;
(iii) applying the 3D printing composition onto a surface and allowing the structure to harden.

Preferably, component A further comprises
a5) one or more granular filler(s),
   and/or one or more reactive aggregates.

“Applying” in the above process means, that the 3D printing composition is paced by a printing device in its intended end-location, which can be accomplished by spraying, deposition or other adequate placement. Preferably, the 3D printing composition is placed in the intended end-location in the form of a continuous strand as is regularly the case in a 3D mortar extrusion printing process.

As concerns preferred and suitable constituents of the mortar base component A and the accelerator component B, reference is made to the above described multi-component composition, where the preferred embodiments likewise are preferred for the method as herein described.

In a preferred embodiment, the step ii) further involves a mixing with a thickener component C to adjust the viscosity of the composition as desired. Particularly preferably, the thickener in this step is an acrylamide based thickener.

Moreover, in the context of the above described process it is preferred that the 3D printing composition is applied to the surface by means of a 3D printing system. In the printing system the dosing of the accelerator component B to the component A is preferably conducted in a printer mixing chamber, where more preferably also a thickener component is concurrently dosed into the component A. Particularly preferably, the mixing chamber is positioned in or just prior to the printing head, where the mixed multi-component composition is discharged from the 3D printing system.

In addition, or alternative thereto, it is preferred that the components a1) to a3) are provided in powder form and are mixed with water to provide the component A. In particular, the mixing is performed in the printing system in a mixing chamber which is positioned upstream in flow direction from (i.e. in flow direction prior to) a mixing chamber, where the accelerator and optional thickener components B and C are admixed with the mortar base component A.

In a yet further aspect, the present application concerns a construction material 3D structure obtainable by the above described process. Examples of such construction material 3D structure include e.g. a wall, a house or a part thereof.

As noted above, the alkali metal aluminate, which is used in the above described process provides the benefit that it does not affect the viscosity when it is added as an accelerator. Nonetheless, in some circumstances such influence may be tolerated so that in a further aspect, the present application also concerns a process for the production of a 3D structure comprising the steps of
(i) providing a mixture of a mortar base component A comprising
   a1) Portland cement as an inorganic binder,
   a2) an amine-glyoxylic acid condensate selected from the group consisting of a melamine-glyoxylic acid condensate, an urea-glyoxylic acid condensate, a melamine-urea-glyoxylic acid condensate and a polyacrylamide-glyoxylic acid condensate and mixtures thereof,
   a3) at least one polyhydroxy compound or salts or esters thereof, and
   a4) water;
(ii) mixing the mortar base component A with an accelerator component B comprising aluminum sulfate to obtain the 3D printing composition;
   depositing the 3D printing composition onto a surface as a continuous strand and allowing the structure to harden.

In a preferred version of the above mentioned process, component A further comprises a5) one or more granular filler(s), and/or one or more reactive aggregates. Reference is made to the explanations on fillers given above.

For preferred embodiments of this process, embodiments, which are indicated as preferred in the above multi-component composition, are likewise deemed as preferred, unless this leads to contradictions. In addition, any preferred embodiment or feature described for one of the above aspects is also a preferred embodiment or feature in the other aspects, unless this combination results in an obvious contradiction.

In the following the present invention will further be describes by means of examples, which however, are only provided for illustrative purposes and should not be construed as limiting to the invention in any manner.

### EXAMPLES

### Example 1

To compare the performance of mortar compositions according to the invention and mortar compositions according to WO 2020/212607 A1 as prior art in a 3-D printing application, as the mortal compositions as shown in the following table 1 were prepared. In the table, sample 1 corresponds to mortar M5 in the table of page 28 of WO2020/212607 A1 without accelerator, sample 2 corresponds to mortar M5 in the table of page 28 of WO2020/212607 A1 with SA167 accelerator, and sample 3 corresponds to an inventive mortar with sodium aluminate accelerator. Sample 4 is a mortar composition according to Example 2 of WO 2020/244981 A1 (composition not shown).

TABLE 1

| Compound/ | | | |
|---|---|---|---|
| additive | Sample 1 | Sample 2 | Sample 3 |

| | | | | | | |
|---|---|---|---|---|---|---|
| CEM I 52.5 R ¹ | 836 | g | 836 | g | 836 | g |
| Norm sand | 1350 | g | 1350 | g | 1350 | g |
| Plasticizer | 0.96 | g | 0.96 | g | 0.96 | g |
| (Melflux ® 6680 L) | | | | | | |

| | | | | |
|---|---|---|---|---|
| Spray Concrete | — | 59 | g | — |

Accelerator
(MasterRoc ® SA
167)

| | | | | |
|---|---|---|---|---|
| Na-aluminate | — | — | 59 | g |

| | | | | | | |
|---|---|---|---|---|---|---|
| (40% aq. | | | | | | |
| solution) | | | | | | |
| BMF² | 8.87 | g | 8.87 | g | 8.87 | g |
| Water | 376.2 | g | 376.2 | g | 376.2 | g |

| | | | |
|---|---|---|---|
| w/c-value | 0.45 | 0.45 | 0.45 |

¹ Mergelstetten CEM I 52.5 R
²= Mixture of glyoxylic acid urea condensate (49.3% solids)/sodium gluconate/sodium carbonate in the weight proportion 3:1:3. The glyoxylic acid urea condensate was prepared as described on page 23 of WO 2020/212607 A1.

The respective mortars were by mixing all components except the accelerator with water for 3 Min 30 sec, adding the accelerator followed by mixing for another 40 sec.

The thus prepared mortars were investigated for their pressure strength and flexural tension according to DIN EN 1015-3. The tap measure was determined according to DIN EN 1015-3 with a Hägermann-extension table. The setting time was determined according to DIN EN 196-3 with a Vicat apparatus with a Vicat cone according to DIN EN 13279-2.

The respective characteristics, as determined in these measurements, are given in the following table 2. Therein VB and VE designate the start and end of stiffening and EB and EE designate the start and end of solidification. The determination of the stiffening is determined by filling the mortar into a hard rubber ring with a height of about 40 mm. Next, a needle (12 g weight) with a diameter of 8 mm and a tapering to a needle point of 1 mm diameter is placed on the surface of the mortar and suddenly released. The start of stiffening (VB) is given as the time that has elapsed from the start of mixing of water and accelerator to the point in time when an attached needle no longer completely penetrates the cake. The end of stiffening (VE) is given as the time which has elapsed from the time of mixing until a needle, which is placed on the mortar, dips into the same by no more than 2 mm. The start of solidification (EB) and the end of the solidification (EE) are determined according to DIN EN 196-3.

TABLE 2

| | | | | Example 2 (WO |
|---|---|---|---|---|
| | Sample 1 | Sample 2 | Sample 3 | 2020/244981)¹ |
| VB [min] | 230 | 31 | 13 | 46 |
| VE [min] | 230 | 31 | 13 | 54 |
| EB [min] | 287 | 31 | 13 | 59 |
| EE [min] | 287 | 31 | 13 | 64 |
| Tap measure | 27.7 | 17.8 | 27.7 | 21.7 |
| pressure | 36.7 | 31.6 | 33.8 | 29.8 |
| strength 28 d | | | | |
| [N/mm²] | | | | |

¹= the example uses calcium silicate hydrate as accelerator

The data in table 2 above shows, that the accelerator according to the invention provides the fastest setting in comparison to mortars with other accelerators. In addition, the sodium aluminate accelerator provides a pressure strength, which is close to the unaccelerated sample, whereas the samples with SA 167 and calcium silicate hydrate accelerator provide final pressure strength, which is somewhat lower. For the “Example 2”-composition, it was further observed that it is less suitable for processing in a 3D printer.

### Example 2

In this example, the effect of adding calcium sulfate was investigated for the inventive mortar. For this the compositions as indicated in the below table 3 (in part by weight) were prepared.

TABLE 3

| | Sample 4 | Sample 5 |
|---|---|---|
| CEM I 52.5 R | 30 | 30 |
| Lime stone flour | 11 | 11 |
| Retarder | 0.6 | 0.6 |
| Al-aluminate solution | 1.15 | 1.15 |
| Calcium sulfate | — | 1.0 |
| (synthetic anhydrite) | | |
| Sand mixture | 58.4 | 58.4 |
| Water | 14.5 | 14.5 |
| w/c-ratio | 0.48 | 0.48 |

Sample 4 and 5 were investigated for their mechanical characteristics as described I Example 1 above. The determined values are given in the following table 4.

TABLE 4

| | Sample 4 | Sample 5 |
|---|---|---|
| Tap measure | 24.4 | 23.5 |
| VB | 10 | 9 |
| VE | 11 | 10 |
| EB | 11 | 11 |
| EE | 12 | 11 |

| | flexural | pressure | flexural | pressure |
|---|---|---|---|---|
| | tension | strength | tension | strength |
| 2 h | n.d. | 3.78 | n.d. | 4.78 |
| 24 h | 4.1 | 14.94 | 7.25 | 38.42 |
| 7 d | 6.66 | 50.7 | 6.81 | 53.15 |
| 28 d | 5.98 | 54.98 | 6.87 | 57.53 |

As is apparent from table 4, the addition of calcium sulfate provides increased pressure strength at all times after setting of the mortar. Accordingly, calcium sulfate promotes ettringit formation in the mortar.

1. A multi-component composition comprising a mortar base component A comprising mixture of:
a1) Portland cement as a hydraulic binder;
a2) an amine-glyoxylic acid condensate selected from the group consisting of a melamine-glyoxylic acid condensate, an urea-glyoxylic acid condensate, a melamine-urea-glyoxylic acid condensate and a polyacrylamide-glyoxylic acid condensate and mixtures thereof;
a3) at least one polyhydroxy compound or a salt or ester thereof;
a4) water;
and an accelerator component B comprising an alkali metal aluminate.

2. The multi-component composition according to claim 1, further comprising a thickener component C.

3. The multi-component composition according to claim 1, further comprising one or more of calcium aluminate cement, sulfoaluminate cement and mixtures thereof as a constituent of the mortar base component A.

4. The multi-component composition according to claim 1, wherein the polyhydroxy compound is selected from sugar alcohols and their condensation products, alkanolamines and their condensation products, carbohydrates, pentaerythritol, trimethylolpropane and a mixture thereof, preferably wherein the polyhydroxy compound is selected from the group comprising glycerol, threitol, erythritol, xylitol, sorbitol, inositol, mannitol, maltitol, and lactitol.

5. The multi-component composition according to claim 1, wherein the component A further comprises at least one granular filler in an amount of 30-90% by weight of the combined weight of the non-aqueous constituents in the mortar base component A.

6. The multi-component composition according to claim 1, wherein the component A further comprises calcium sulfate in an amount of equal to or less than 5 wt.-% of the combined weight of the non-aqueous constituents in the mortar base component A.

7. The multi-component composition according to claim 1, wherein accelerator in the accelerator component B is selected from sodium and potassium aluminate.

8. The multi-component composition according to claim 1, wherein the component B further comprises a soluble sulfate source as constituent of component B.

9. The multi-component composition according to claim 2, wherein the non-aqueous constituents of the mortar base component A account for 99 to 90 wt.-% of the composition, the accelerator component B accounts for 1 to 5 wt.-% of the composition and the optional thickener component C accounts for 0.5 to 5 wt.-% of the composition, each on dry basis.

10. The multi-component composition according to claim 1, further comprising one or more additives selected from a dispersing agent, a rheology additive, a surfactant or flowing agent, a carbonate source, a hydroxylic acid, a shrinkage reducer, an (air) pore former and a filler as a constituent of either of the components of the composition.

11. The multi-component composition according to claim 1, which has a water cement ratio in the range of from 0.2 to 1.0 and/or wherein the water cement ratio of the component A is within this range.

12. A cementitious composition obtained or obtainable by mixing all components of the multi-component composition in claim 1.

13. The cementitious composition according to claim 11, which 2 h after mixing has a compressive strength of at least 1 N/mm² and optionally 28 days after mixing has a compressive strength of at least 40 N/mm2.

14. A process for the production of a 3D structure comprising the steps of:
(i) providing a mixture of a mortar base component A comprising:
a1) Portland cement as a hydraulic binder;
a2) an amine-glyoxylic acid condensate selected from the group consisting of a melamine-glyoxylic acid condensate, an urea-glyoxylic acid condensate, a melamine-urea-glyoxylic acid condensate and a polyacrylamide-glyoxylic acid condensate and mixtures thereof,;
a3) at least one polyhydroxy compound or salts or esters thereof; and
a4) water;
(ii) mixing the mortar base component A with an accelerator component B comprising an alkali metal aluminate to obtain the 3D printing composition; and
(iii) applying the 3D printing composition onto a surface and allowing the structure to harden.

15. The process of claim 14, wherein component A further comprises
a5) at least one granular filler.

16. The process of claim 14, wherein the step ii) further involves a mixing with a thickener component C.

17. The process according to claim 14, wherein the 3D printing composition is applied to the surface by means of a 3D printing device, by dosing the accelerator component B to the component A in a printer mixing chamber.

18. The process according to claim 14, wherein the components a1) to a3) are provided in powder form and are mixed with water to provide the component A.

19. A construction material 3D structure obtainable by the process according to claim 14.

20. A process for the production of a 3D structure comprising the steps of:
(i) providing a mixture of a mortar base component A comprising:
a1) Portland cement as an inorganic binder,
a2) an amine-glyoxylic acid condensate selected from the group consisting of a melamine-glyoxylic acid condensate, an urea-glyoxylic acid condensate, a melamine-urea-glyoxylic acid condensate and a polyacrylamide-glyoxylic acid condensate and mixtures thereof;:
a3) at least one polyhydroxy compound or salts or esters thereof; and
a4) water;
and
a5) at least one granular filler;
(ii) mixing the mortar base component A with an accelerator component B comprising aluminum sulfate to obtain the 3D printing composition; and
(iii) depositing the 3D printing composition onto a surface as a continuous strand and allowing the structure to harden.
